(19) United States
(12) Patent Application Publication
(10) Pub. No.: US 2010/0065038 A1
(43) Pub. Date: Mar. 18, 2010

(54) Exhaust Canopy

(76) Inventor: John Mills Davies, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/559,485

(22) Filed: Sep. 14, 2009

Related U.S. Application Data
(60) Provisional application No. 61/191,838, filed on Sep. 13, 2008.
(60) Provisional application No. 61/192,141, filed on Sep. 16, 2008.

(51) Int. Cl. F24C 15/20

(52) U.S. Cl. 126/299 D

(57) ABSTRACT

A stove vent and canopy positionable above a cooking surface to any of a plurality of positions between a fully retracted position and a fully extended position. In a fully retracted position, the vent is positionable immediately adjacent to the surface allowing for venting of cooking vapors without blocking the user's view over the stove. Telescoping to the fully extended to position places the vent over the cooking surface and may employ a clear backsplash to continue to maintain the user's view behind the cooking surface.

This application claims priority to U.S. Provisional Patent Applications No. 61/191,838 filed on Sep. 13, 2008 and U.S. Provisional Patent Applications No. 61/192,141 filed on Sep. 16, 2008, both of which are respectively incorporated herein in their entirety by reference.

### FIELD OF THE INVENTION

The disclosed device and method herein relates to the ventilation of cooking appliances such as gas and electric stoves. More particularly, the disclosed device relates to an improved exhaust canopy which translates to a plurality of positions adjacent to, or above, the cooking surface of a stove or similar cooking appliance. The variable positioning of the venting intake allows for customization of the position of the exhaust intake aperture of the device to maximize ventilation to the current cooking needs of the user on the cooking surface. Aesthetics are also improved from prior art devices which generally lack the configurable functionality of the device disclosed herein.

### BACKGROUND OF THE INVENTION

Exhaust or range hoods are widely employed in kitchens in the United States and most modern countries to ventilate the air above the cooking surface during the preparation of a meal or food on the cooking surface. Employing an intake aperture which develops negative pressure through the employment of a communicating exhaust fan, conventional exhaust hoods are employed to remove airborne grease, combustion products, smoke, odors, heat, and steam from the air above and adjacent to the cooking surface of a stove, by a combination of filtration and evacuation of the air. The constant evacuation of atmosphere above the stove cooking surface, concurrent with the preparation of food thereon, insures that the user and occupants of the home or business where the cooking is taking place, are not subjected to a kitchen full of smoke or steam or overpowering cooking odors during food preparation on the cooking surface.

Conventionally, exhaust hoods employ three main components to vent the air above the cooking surface. A skirt or similar capture component funnels the rising gases into a conduit in which negative pressure has been generated. The gases are captured due to the fact that heated gases rise and the negative pressure in the exhaust conduit draws in surrounding air to replace evacuated air in the conduit.

One or a plurality of filters are generally employed to deal with grease and smoke which tend to accompany the rising hot gases from cooking. Negative pressure is generated by a fan or r tangential blower communicating with the exhaust conduit which is in a sealed engagement with the hood funneling the gases into the exhaust conduit.

Modernly, two types of exhaust hoods have developed and are both widely employed. A first type of exhaust hood is a ducted hood which features an intake conduit engaged to the hood which communicates along a sealed pathway with an exhaust aperture located outside the building in which the hood is employed. Another type of exhaust hood is the ductless or recirculating exhaust hood which ducts the gases from the cooking surface area through a filter containing activated charcoal or the like to remove odor and smoke particles from the air, before releasing the cleaned air back into room from which it was taken.

Generally, a ducted application is preferable since communicates all forms of airborne contamination outside the building, while a ductless application will recirculate cleaned air with heat and moisture into the kitchen environment. Additionally, a ducted configuration eliminates the need for replacing the filters required of the ductless hood on a regular basis.

Exhaust hoods in most kitchens generally also include built-in lighting (incandescent, fluorescent, or halogen) to illuminate the underlying cooking surface. In addition, some types of exhaust hoods provide matching optional components such as a backsplash panel or shelves for spices and thereby provide increased utility for the user.

Modern kitchens have evolved in recent decades to become larger and offer more utility and also have become more eye pleasing. This evolution has in many cases moved the stove from a positioning along a counter top located against a kitchen wall to a position in the middle of the kitchen on an island style counter. Such island placements position the cooking surface more centrally located in the room, and allow more than one person to partake in the cooking experience.

However, such island locations for the stove also present problems as to venting of the cooking gases during use. Since modern kitchens can have thousands of dollars invested in aesthetic components such as granite counter tops, can style lighting, and other eye pleasing design features, a large exhaust hood dropping from the ceiling in the middle of the room is not well received. A huge canopy or hood adapted to draw the gases and cooking fumes in the middle of a kitchen becomes an eyesore. It also can severely restrict the communication of overhead lighting to the cooking surface. Consequently other designs have appeared to address the concerns of a centrally positioned stove in a kitchen.

One such advance is the employment of a telescoping exhaust system which translates slightly above the counter top surrounding the stove during use. Intake apertures pull air from positions slightly above the counter top and adjacent to the side of the cooking surface. In this low position the intake does not obscure the view and the but retracts when not needed. Such retractable stove exhaust systems however are less than efficient because they are adapted to pull the air rising from the cooking surface into intake apertures immediately adjacent or on the sides of the cooking surface rather than overhead. Since hot cooking gases such as steam and smoke, inherently rise, conventional retractable exhaust systems offer less than optimum performance. The heat-propelled gas is rarely all pulled into the intake apertures of these retractable exhaust components and thus smoke and grease invariably end up upon the ceiling and floors of the kitchen rather than fully captured as would occur with an overhead exhaust hood.

Additionally, the retractable systems lack any provision for a backsplash or additional overhead lighting for the user. This is because they generally rise a short distance above the counter top and lack the structure to provide a tall backsplash or a means to position downward focused lighting overhead.

As such there exists an unmet need for a cooking surface exhaust system, for venting stoves which are centrally positioned in a room, which provides the benefits of an overhead positioning of an intake aperture to takes advantage of the natural proclivity of heated gases to rise where they may be captured and vented. Such a device and system in addition to providing overhead capture of gasses should be esthetically pleasing and should afford the option of overhead lighting which may be focused upon the cooking surface. Still further such a device and system should provide for a backsplash to prevent grease and the like from flying about the kitchen during cooking. Also, such a system and device should also provide such an overhead intake and backsplash while concurrently providing a view of the cooking surface from all sides of an island or centrally positioned stove.

With respect to the above, before explaining at least one preferred embodiment of the cooking surface ventilation system herein in detail or in general, it is to be understood that the range hood disclosed herein is not limited in its application to the details of construction and to the arrangement of the components or the steps in the method of employment set forth in the following description or illustrated in the drawings. The various methods and combinations of methods and apparatus of the disclosed invention are capable of other embodiments, and of being practiced and carried out in various ways, all of which will be obvious to those skilled in the art once the information herein is reviewed. Also, it is to be understood that the phraseology and terminology employed herein are for the purpose of description and should not be regarded as limiting in any manner.

As such, those skilled in the art will appreciate that the conception upon which this disclosure is based, may readily be utilized as a basis for designing a ventilation system for a cooking surface such as a stove, and for carrying out the several purposes of the present disclosed device. It is important, therefore, that the embodiments, objects and claims herein, be regarded as including such equivalent methodology and operational components insofar as they do not depart from the spirit and scope of the present invention.

### SUMMARY OF THE INVENTION

The present invention places the exhaust intake directly above the cooking surface to maximize the communication of hot gases and steam into the exhaust conduit. However, the disclosed device also will retract completely into the counter or island surrounding the cooking surface when desired, and therefor out of the line of sight when not in use.

Still further, employing the unique translating telescopic deployment of the hidden exhaust canopy, and dual independent means for translation of each telescoping component, the device allows for placement of the intake aperture at points in-between the totally retracted state, to the fully deployed state. This provides the user with additional utility by being able to adjust the device to an optimum mix of performance and Aesthetics in the room. When employed for exhausting a cooking surface that is located in an open room, such as on a kitchen island or peninsula, the user may keep it lower when the room is full of people or may raise it entirely when alone or when the view through the room is not an issue.

Additionally the disclosed device allows for the employment of a glass or transparent plastic panel as a backsplash thereby providing a minimally interrupted line of sight during use. Or, other types of panels may be fitted to the backsplash area of the device using various decorative materials of the owner's choice to match the room decor.

Further, the disclosed device using a glass or plastic backsplash, may also provide a heads-up display screen on the glass by employing a small projector adapted to that task. This will allow an open view of the cooking through the glass, and allow the user to project indica onto the glass such as recipes they are currently working upon on the cooking surface.

In a first mode of the device vertical and horizontal translation of the components is provided. A pair of vertical supports are translatable vertically to any point above the cooking surface deemed appropriate. A canopy engaged to the distal end of the vertical supports is translatable horizontally to cover the cooking surface or to cover both the cooking surface and a rearward portion of the counter, or cover just the rearward portion of the counter top. The canopy communicates the exhaust air from the canopy in any position and down the vertical supports to a vent from the building.

A second mode of the device employs a two piece translatable device which translates along an arc. Both components being independently translatable to their own positions allows the user to position the intake aperture anywhere along the translational arc from a few inches above the counter to fully deployed and hanging above the cooking surface.

This arc-shaped telescopic mode of the device allows for a variable height backsplash which may be from glass or plastic to minimize room view obstruction. An optional heads up display may be employed to project indicia or pictures on the backsplash for the user.

The foregoing has outlined rather broadly the more pertinent and important features of the cooking surface canopy device and method of employment thereof herein allowing for a range hood which is retractable and positionable to a plurality of positions above and adjacent to a cooking surface. This is provided in order that the detailed description of the invention that follows may be better understood so that the present contribution to the art may be more fully appreciated. Additional features of the invention will be described hereinafter which form the subject of the claims of the invention.

It should be appreciated by those skilled in the art that the conception and the disclosed specific embodiment may be readily utilized as a basis for modifying or constructing retractable ventilation systems for cooking surfaces and for carrying out the same purposes of the present invention. It should also be realized by those skilled in the art that such equivalent constructions and methods do not depart from the spirit and scope of the invention as set forth in the appended claims.

In this respect, before explaining at least one embodiment of the invention in detail, it is to be understood that the invention is not limited in its application to the details of construction and to the arrangement of the steps or actions set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### THE OBJECTS OF THE INVENTION

It is therefore an object of the present invention to provide a cooking surface ventilation system which is retractable when not in use and thereby contributes to the visual Aesthetics in a modern kitchen.

It is a further object of the present invention to provide such a cooking surface vent which in addition to being retractable from sight, allows a plurality of positions for use between a fully retracted position and a fully extended position.

Yet another object of the invention is the provision of such a cooking surface ventilation system which provides an overhead mount for lighting of the cooking surface.

It is another object of this invention to provide such a cooking surface ventilation system which also provides a backsplash which does not block the view of the cooking surface from a position behind the backsplash.

It is another object of this invention to provide such a cooking surface ventilation system and device which allows for a heads-up display for the user to view desired information thereon during use.

The foregoing has outlined some of the more pertinent objects of the invention. These objects should be construed to be merely illustrative of some of the more prominent features and applications of the intended cooing surface ventilation invention. Many other beneficial results can be attained by applying the disclosed device in a different manner or by modifying the invention herein within the scope of this disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

The accompanying drawings, which are incorporated in and form a part of this specification, illustrate embodiments of the invention and together with the detailed description, serve to explain the principles of this invention without placing limitation thereon.

FIG. 1 depicts a perspective view of the mode of the device that is adjustable in two planes adjacent to or over the cooking surface in a fully elevated and deployed position.

FIG. 2 shows the device of FIG. 1, or FIG. 8 in a hidden position fully retracted into the counter or island.

FIG. 3 is a sliced view through the counter and the vertical and horizontal components of the device showing translational range.

FIG. 4 depicts the worm and gear means to rotate the canopy portion of the device of FIGS. 1 and 3.

FIG. 5 depicts the worm and gear powered means to translate the vertical components of the device of FIGS. 1 and 3 to any point between fully upright and fully retracted.

FIG. 6 depicts the horizontal translational capability of the canopy and the plurality of positions provided allowing for air evacuation from the canopy.

FIG. 7 shows the structure of FIG. 6 from a frontal view and shows the one way flow of evacuated air and gas taken in by the exhaust aperture in the canopy.

FIG. 8 depicts the two part telescopic arc shaped mode of the device herein also having two independently positionable components.

FIG. 9 depicts a slice through and edge of FIG. 8 and shows the means to translate the sections which are substantially as depicted in FIGS. 4 and 5.

FIG. 10 depicts the exhaust air flow through the disclosed device of FIG. 1 and out of the structure.

### DETAILED DESCRIPTION OF THE PREFERRED Embodiments of the Invention

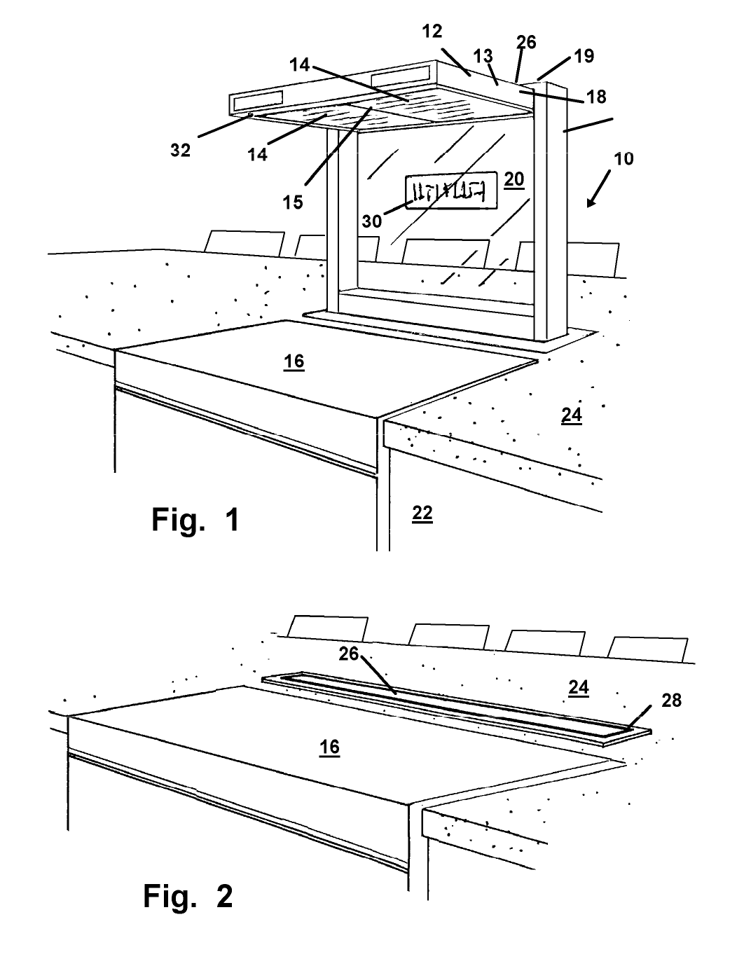

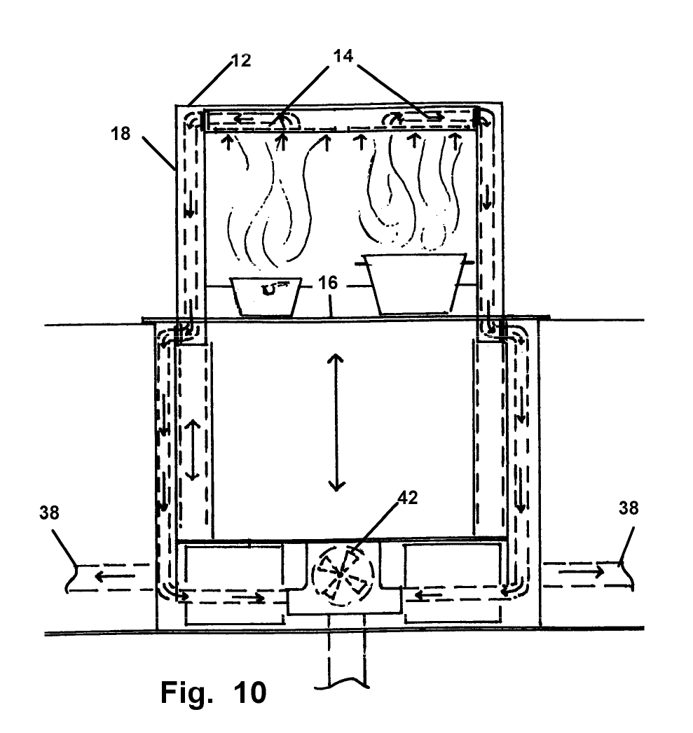

Referring now to the drawings in FIGS. 1-10, wherein similar components are identified by like reference numerals, there is seen in FIG. 1, a first mode of the telescoping and translating range canopy device 10 which provides translational function in two planes independently as a means to precisely position the canopy 12 and intake apertures 14 over the cooking surface 16 and concurrently preserver aesthetic and viewing aspects of the room as required.

The device 10 is shown in FIG. 1 in the fully elevated position wherein the vertical members 18 having their distal ends 19 fully extended from the cooking surface 16. A backsplash 20 is seen which is preferably transparent to preserve the open view in the room, and allow for viewing of the cooking from the area behind the backsplash 20 for classes or if guests or family wish to watch the user.

The device 10 as depicted in FIG. 2, is fully retractable into the underlying cupboard 22 supporting the counter top 24 surrounding the cooking surface 16. The cross member 26 provides a closure to the aperture 28 in the counter top 24 when the device 10 is in the fully retracted position of FIG. 2.

As noted, the backsplash 20 is preferably transparent and in this mode provides a screen on which a heads-up display of indicia 30 may be projected by projector 32. This allows the cook to view recipes or the like during use, or to project the heads-up display indica 30 backwards so that persons sitting behind the backsplash 20 may read it during use of the cooking surface 16 to cook such as students or guests interested in the cooking endeavors.

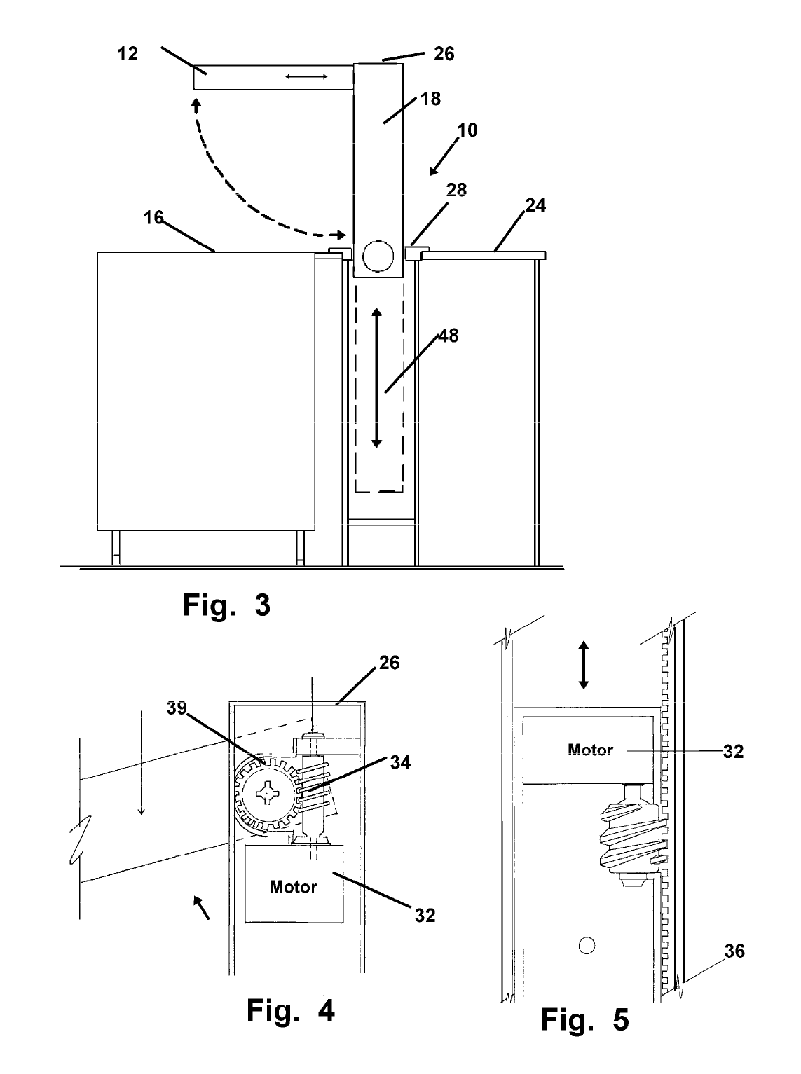

As shown in FIG. 3, the device 10 is vertically translatable from the retracted position of FIG. 2 to the fully extended position above the cooking surface 16. Means for translation of the vertical members 18 allows a user to energize a motor 32 to rotate worm gear 34 to cause elongated gear 36 to translate vertically depending on the direction of rotation of the motor. A remote or other control conventionally employ to control motors would be used. Precise vertical position of the canopy 12 a distance above the cooking surface 16 is thus provided.

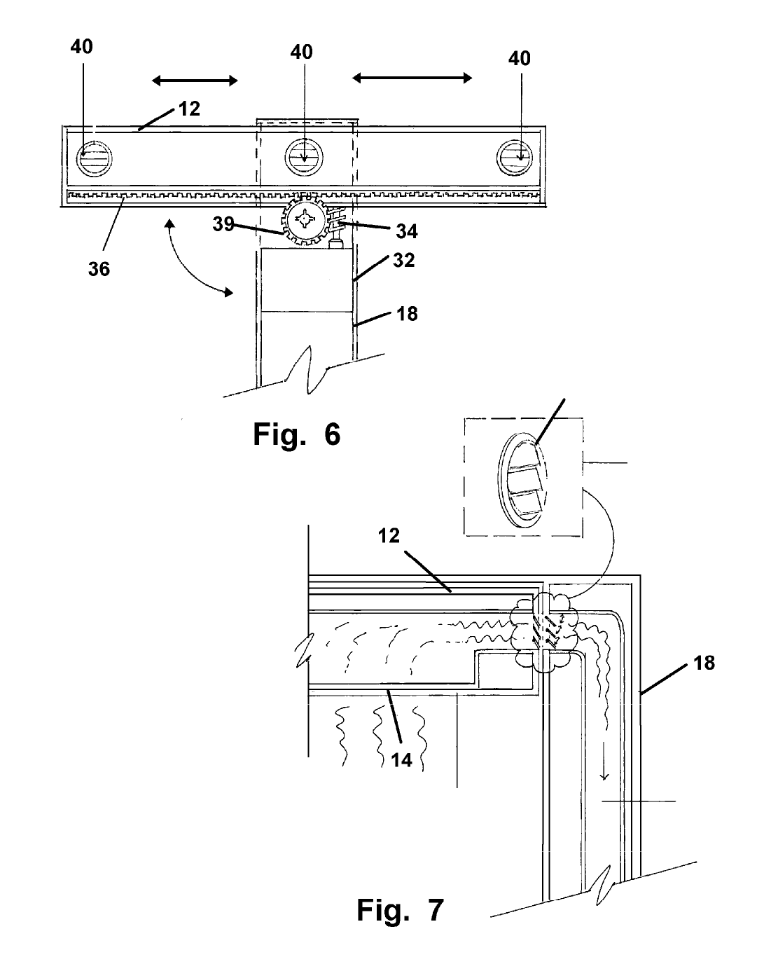

As noted in FIG. 3 and FIG. 6, the canopy 12 is independently translatable horizontally parallel to the cooking surface 12. Employing a similar motor 32 and controller, the worm gear 34 will rotate the canopy 12 horizontal to the cooking surface 16 first once the vertical members 18 are sufficiently extended. Once so positioned, the canopy 12 may then be horizontally translated parallel to the cooking surface 16 and counter top 24 suing the motor and gear configuration of FIG. 5 shown in FIG. 6. This allows precise positioning of the intake apertures 14 and light 15 over the cooking surface 16. Or it allows the canopy 12 to be translated behind the backsplash 20 for all or a portion of the distance of width of the canopy 12.

As depicted in FIGS. 5-6 and 10, airflow through the device 10 is provided by negative pressure communicated to the intake aperture 14 and through a sealed communication to an exhaust 38 exiting the structure. The vertical members 18 and horizontal members 13 making up the canopy 12 frame has hollow interiors in sealed engagement to provide the sealed communication between the intake aperture 14 and the exhaust aperture 38. As shown in FIG. 6-7 a one way valve seat 40 is in registered sealed engagement with the internal conduit 42 communicating to the intake aperture 14 through the vertical members 18 and horizontal members 13. The intake aperture 14 will thus continue to communicate negative pressure above the cooking surface 16 when the canopy 12 translates to the three positions. A fan 42 generates the negative pressure for the system.

Thus the first mode of the device 10 of FIG. 1, provides great utility in that is positionable in an infinite number of heights and horizontal positions by independent adjustment of the means to translate the vertical members 18 and means to translate the canopy 12 by the user. Constant negative pressure is communicated to the intake aperture and the transparent backsplash provides additional utility.

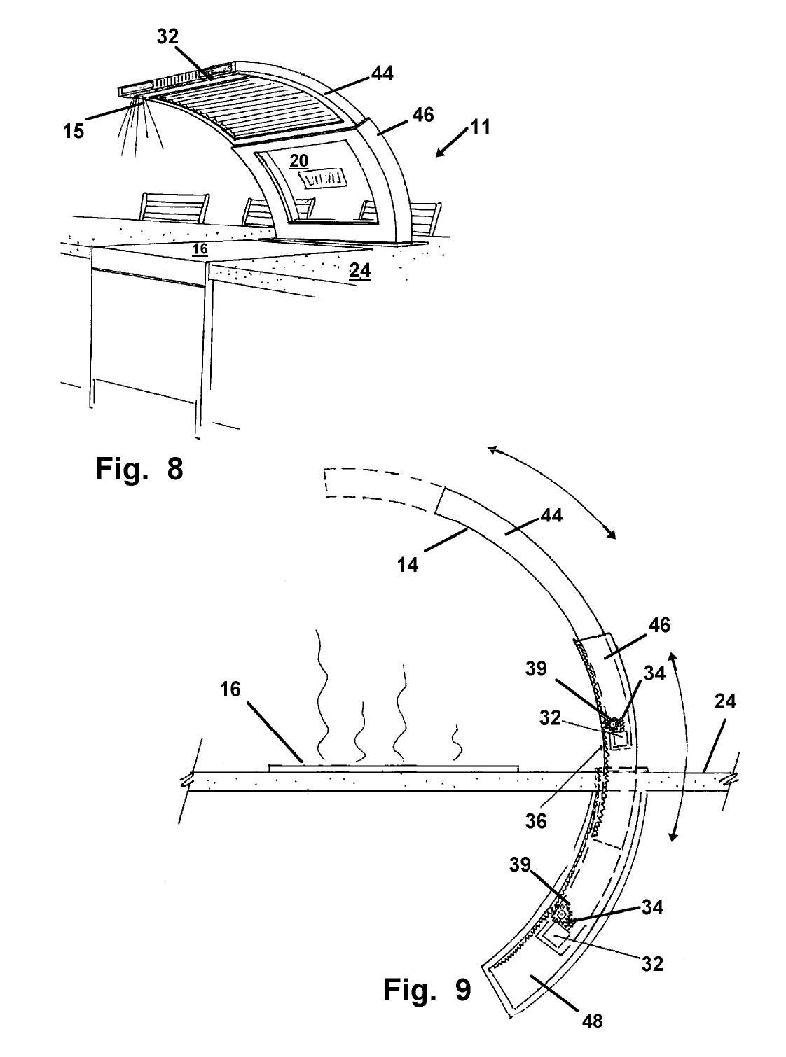

Another mode of the device 11 is shown in FIGS. 8-9 and provides the same infinite adjustment ability as that of FIG. 1. Two independently translatable components are controlled by the user to position the intake aperture 14 above the cooking surface 16. Using the worm and gear components of FIG. 5, or other means to independently translate a first arc-shaped member 44 hosting the intake aperture 14, inside of a second arc-shaped member 46, the user may make minute adjustment to either independently.

The first arc-shaped member may thus be adjusted independently inside the second arc-shaped member 46 in which it is translationally engaged. The second arc-shaped member 46 is translationally engaged within the slot 48 in the underlying cupboard 22. When fully retracted this second mode of the device 11 will appear substantially the same as FIG. 2 wherein the top of the second arc-shaped component is flush with the counter top 24.

Independent adjustment of both the height and horizontal position of the intake aperture 14 allows for the device 11 to be very low and draw from a side position or fully deployed as in FIG. 8 and drawing air from overhead.

The employment of the same transparent backsplash 20 affords the user the best view of the area behind the backsplash as well as a view of the cooking surface 16 for persons behind the backsplash 20. Indica in a heads up display would be presentable in fashion noted above.

While all of the fundamental characteristics and features of the disclosed cooking surface canopy with vertical and horizontal adjustment have been described herein, with reference to particular embodiments thereof, a latitude of modification, various changes and substitutions are intended in the foregoing disclosure and it will be apparent that in some instances, some features of the invention will be employed without the corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

Further, the purpose of the herein disclosed abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. A vent positionable above a cooking surface positioned adjacent to a counter top supported by a cupboard, comprising:
a first support, said first support vertically disposed in a translational engagement in a slot formed under said counter top;
said first support having a first end engaged in said slot and a distal end opposite said first end;
means to translate said first support in said slot to position said distal end at any point between a maximum distance above said counter top and a minimum distance above said counter top;
a canopy, said canopy having an intake aperture engaged along a sealed conduit communicating with a source of negative air pressure, said canopy rotationally engaged adjacent to said distal end of said first support;
said canopy having a first position substantially parallel to said first support when said first support is translated within said slot;
said canopy translatable into said slot formed under said counter top while in said first position;
said canopy having a second position rotated substantially perpendicular to said first support;
means to rotate said canopy between said first position and said second position;
said means to translate said first support having a control, said control activatable by a user to translate said first support; and
said intake aperture positionable above said cooking surface to a plurality of positions distanced therefrom by a translation of said first support to place said distal between said maximum distance above said counter top and said minimum distance above said counter top.

2. The vent positionable above a cooking surface of claim 1, additionally comprising:
means to translate said canopy while in said second position; and
said intake aperture positionable to different positions over said cooking surface between said first support and a front edge of said cooking surface by said means to translate said canopy while in said second position.

3. The vent positionable above a cooking surface of claim 1, additionally comprising:
a backsplash engaged with said first support;
said backsplash having an upper edge translatable closer to and further from said cooking surface by a translation of said vertical support; and
said backsplash being substantially transparent thereby providing means for viewers positioned on an opposite side of said backsplash from said cooking surface, means to view said cooking surface therethrough, when said upper edge is positioned elevated above said cooking surface.

4. The vent positionable above a cooking surface of claim 3, additionally comprising:
a projector engaged to one of said canopy, said first support or said cooking surface; and
said projector providing means to project indicia upon said backsplash in a heads-up display.

5. The vent positionable above a cooking surface of claim 1, additionally comprising:
said first support formed of two supports a spaced distance apart and vertically disposed in a translational engagement in a slot formed under said counter top;
said canopy engaged each on two side rails to one respective of said two supports;
a pair of front rails extending between said side rails on opposite ends of said side rails;
said canopy translatable to canopy positions along said side rails with respective said two supports using means to translate said canopy with said two supports; and
said canopy positions each placing said intake aperture in a different position relative to said coking surface.

5. The vent positionable above a cooking surface of claim 3, additionally comprising:
said first support formed of two supports a spaced distance apart and vertically disposed in a translational engagement in a slot formed under said counter top;
said backsplash extending between said two supports;
said canopy engaged each on two side rails to one respective of said two supports;
a pair of front rails extending between said side rails on opposite ends of said side rails;
said canopy translatable to canopy positions along said side rails with respective said two supports using means to translate said canopy with said two supports; and
said canopy positions each placing said intake aperture in a different position relative to said coking surface and closer or further away from said two supports depending on the direction of translation imparted.

6. A vent positionable above a cooking surface comprising:
a first arced planar component translationally engaged in a slot depending below a counter top adjacent to a cooking surface;
a second arced planar component translationally engaged within a axial chamber in said first arched planar component;
said second arced planar component having an intake aperture in a lower surface, facing said cooking surface, said aperture in sealed communication through a conduit, with a negative air pressure source;
translation of said first arced planar component above and below said counter top being independent of translation of said second arched planar component translationally engaged within said first;
whereby a height of that intake aperture above said cooking surface can be adjusted independently by translation of said first component or said second component thereby placing said intake aperture closer or further from the cooking surface; and
a distance of said intake aperture closer to and away from said slot hosting said first arced planar support may also be adjusted by translation of said first or second components.

7. The vent positionable above a cooking surface additionally comprising:
said first support formed by two curved members with a glass backsplash communicating therebetween; and
said backsplash providing means for a user to see behind the backsplash and people sitting behind the backsplash to see the user in action.
